(19) United States
(12) Patent Application Publication
(10) Pub. No.: US 2003/0098532 A1
(43) Pub. Date: May 29, 2003

(54) Powertrain mount with floating track

(75) Inventors: Sanjiv G. Tewani, Lebanon, OH (US); Mark W. Long, Bellbrook, OH (US); Mark O. Bodie, Dayton, OH (US); James P. Hamberg, Tipp City, OH (US)

Correspondence Address: DELPHI TECHNOLOGIES, INC., Legal Staff Mail Code: 482-204-450, 1450 W. Long Lake, P.O. BOX 5052, Troy, MI, 48098, US

(73) Assignee: DELPHI TECHNOLOGIES INC.

(21) Appl. No.: 09/997,745

(22) Filed: Nov. 29, 2001

(51) Int. Cl. F16F 9/00; F16F 15/00

(52) U.S. Cl. 267/140.11

(57) ABSTRACT

A powertrain mount comprises an orifice plate and a slug. The orifice plate defines an orifice track having a first cross-sectional area. The slug is disposed in the orifice track, and has a bore with a second cross-sectional area less than the first cross-sectional area.

### TECHNICAL FIELD OF THE INVENTION

The present invention relates to powertrain mounts for motor vehicles, and more particularly to a powertrain mount with a floating orifice track.

### BACKGROUND OF THE INVENTION

It is desirable to provide motor vehicles with improved operating smoothness by damping and/or isolating powertrain vibrations of the vehicle. A variety of mount assemblies are presently available to inhibit such engine and transmission vibrations. Hydraulic mount assemblies of this type typically include a reinforced, hollow rubber body that is closed by a resilient diaphragm so as to form a cavity. This cavity is separated into two chambers by a plate. A first or primary chamber is formed between the partition plate and the body, and a secondary chamber is formed between the plate and the diaphragm.

The chambers may be in fluid communication through a relatively large central passage in the plate, and a decoupler may be positioned in the central passage of the plate to reciprocate in response to the vibrations. The decoupler movement alone accommodates small volume changes in the two chambers. When, for example, the decoupler moves in a direction toward the diaphragm, the volume of the portion of the decoupler cavity in the primary chamber increases and the volume of the portion in the secondary chamber correspondingly decreases, and vice-versa. In this way, for certain small vibratory amplitudes and generally higher frequencies, fluid flow between the chambers is substantially avoided and undesirable hydraulic damping is eliminated. In effect, the decoupler is a passive tuning device.

As an alternative or in addition to the relatively large central passage, an orifice track is normally provided. The orifice track has a relatively small, restricted flow passage extending around the perimeter of the orifice plate. Each end of the track has an opening, with one opening communicating with the primary chamber and the other with the secondary chamber. The orifice track provides the hydraulic mount assembly with another passive tuning component, and when combined with the decoupler, provides at least three distinct dynamic operating modes. The particular operating mode is primarily determined by the flow of fluid between the two chambers. More specifically, small amplitude vibrating input, such as from relatively smooth engine idling or the like, produces no damping due to the action of the decoupler, as explained above. In contrast, large amplitude vibrating inputs, such as large suspension inputs, produce high velocity fluid flow through the orifice track, and an accordingly high level of damping force and desirable control and smoothing action. A third or intermediate operational mode of the mount occurs during medium amplitude inputs experienced in normal driving and resulting in lower velocity fluid flow through the orifice track. In response to the decoupler switching from movement in one direction to another in each of the modes, a limited amount of fluid can bypass the orifice track by moving around the edges of the decoupler, smoothing the transition.

Passive hydraulic mounts are tuned to provide damping in a pre-determined frequency range which is typically in the range of about 10-15 Hz. Due to the generation of damping, the dynamic stiffness of the mount is increased significantly. An increase in dynamic stiffness is not desirable from the isolation point of view.

### SUMMARY OF THE INVENTION

The present invention is a powertrain mount comprising an orifice plate and a slug. The orifice plate defines an orifice track having a first cross-sectional area, and the slug is disposed in the orifice track. The slug has a bore with a second cross-sectional area less than the first cross-sectional area.

Accordingly, it is an object of the present invention to provide an improved powertrain mount of the type described above with a relatively low dynamic stiffness at a disturbance frequency such as engine idle or some other predetermined mode of operation of the engine.

Another object of the present invention is to provide an improved powertrain mount of the type described above including a slug which floats in the orifice track.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a cross-sectional view of a powertrain mount according to the present invention for a motor vehicle; and

FIG. 2 is a cross-sectional view of a portion of the powertrain mount taken along line 2-2 in FIG. 1.

### DETAILED DESCRIPTION OF THE PRESENTLY PREFERRED EMBODIMENTS

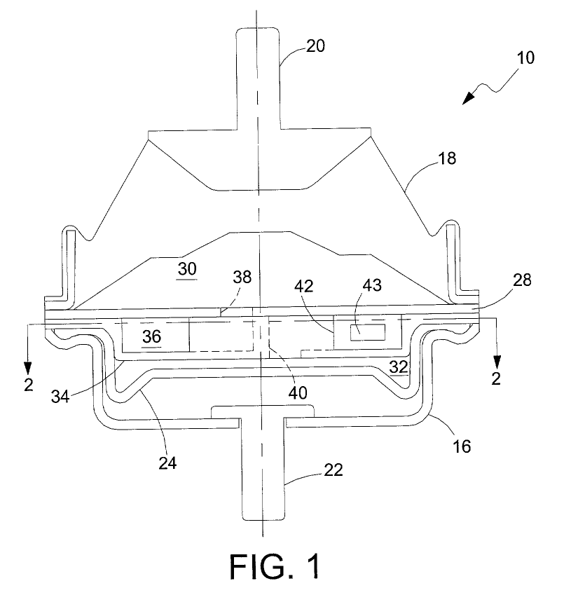

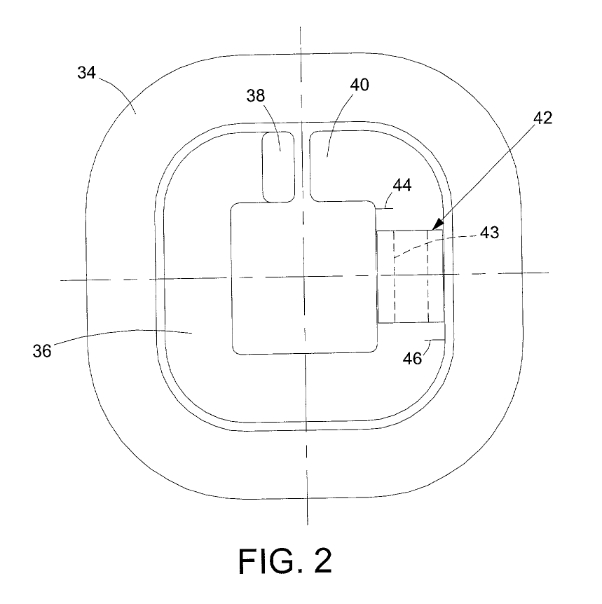

FIGS. 1 and 2 show an improved hydraulic mount assembly 10 according to the present invention. The mount assembly 10 is particularly adapted for mounting an internal combustion engine and/or transmission to a frame in a motor vehicle. The mount assembly 10 includes a metal base plate 16 and a molded body 18. The molded body 18 has an elastomeric portion molded around a metal substrate, and includes a plurality of studs 20 projecting outwardly to attach the molded body to the engine or transmission. The base plate 16 is similarly equipped with a plurality of outwardly projecting studs 22 to attach the base plate to the frame.

The base plate 16 and the molded body 18 are configured to be joined to form a hollow cavity for receiving a damping liquid, such as a glycol fluid. An elastomeric diaphragm 24 of natural or synthetic rubber is attached around its perimeter to the base plate 16 and/or to the body 18, and extends across the cavity. The diaphragm 24 may include an annular rim section having a radially inwardly facing internal groove formed between upper and lower shoulders such as is described in U.S. Pat. No. 5,263,693, the disclosure of which is hereby incorporated by reference. The shoulders are normally flexible so as to sealingly receive the periphery of a die-cast metal or plastic partition plate 28.

The partition plate 28 spans the cavity to define a primary chamber 30 and a secondary chamber 32. With a containment plate 34, the partition plate 28 defines an orifice track 36. The orifice track permits the flow of fluid between the primary chamber 30 and the secondary chamber 32, as is well known. To this end, an entrance 38 is provided in the orifice plate 28, and an exit 40 is provided in the containment plate 34.

A floating orifice track or slug 42 is disposed in the orifice track 36. The slug 42 has an outside dimension closely sized to the inside dimension of the orifice track, and is movable along a portion of the orifice track. The slug 42 also has a bore 43 which may have either a constant or a varying cross-sectional area. In either event, the effective cross-sectional area of the bore 43 is less than the cross-sectional area of the orifice track 36.

To limit the movement of the slug, mechanical stops 44 and 46 may be provided in addition to the usual bends in the orifice track. The length of free travel of the slug 42 is chosen such that its movement is not restricted during small amplitude input displacements to the mount. In this case, the relatively large cross-sectional area of the orifice track 36 primarily influences the flow characteristics of the fluid. The track is designed such that the fluid in the track goes into resonance at the frequency where a low dynamic stiffness is desired. The force associated with the fluid flow therefore attempts to cancel the force associated with the static stiffness of the mount. For large input displacements, the slug 42 reaches the limits of the free space. When the slug 42 is at one of its limits, the flow of the fluid is primarily influenced by the smaller cross-sectional area of the bore 43.

The hydraulic mount 10 is designed such that during engine idle conditions, the mount generates a dynamic stiffness much lower than its static stiffness at a frequency related to engine idle RPM. Based on the application, the mount may likewise be tuned to provide a low dynamic stiffness at a different frequency. At the same time the hydraulic mount generates damping for large road inputs, and as a result higher dynamic stiffness to control the powertrain. For a typical four cylinder engine, isolation during engine idle conditions requires the mount to generate a low dynamic stiffness at around 20 Hz. For control during large road inputs, the powertrain mount 10 generates damping and large dynamic stiffness in the frequency range of about 10-15 Hz.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are embraced therein.

What is claimed is:

1. A powertrain mount comprising:
an orifice plate defining an orifice track having a first cross-sectional area; and
a slug disposed in the orifice track, the slug having a bore with a second cross-sectional area less than the first cross-sectional area.

2. The powertrain mount of claim 1 further comprising at least one stop disposed in the orifice track.

3. The powertrain mount of claim 2 wherein the at least one stop limits travel of the slug in the orifice track.

4. The powertrain mount of claim 1 wherein the bore has a constant cross-sectional area.

5. A powertrain mount comprising:
a base plate;
a molded member connected to the base plate;
an orifice plate connected to one of the base plate or the molded member, the orifice plate defining an orifice track having a first cross-sectional area; and
a slug disposed in the orifice track, the slug having a bore with a second cross-sectional area less than the first cross-sectional area.

6. The powertrain mount of claim 5 further comprising at least one stop disposed in the orifice track.

7. The powertrain mount of claim 6 wherein the at least one stop limits travel of the slug in the orifice track.

8. The powertrain mount of claim 5 wherein the bore has a constant cross-sectional area.

9. A mount for a powertrain component of a motor vehicle, the mount comprising:
a base plate;
a molded member connected to the base plate;
an orifice plate connected to one of the base plate or the molded member, the orifice plate defining an orifice track having a first cross-sectional area; and
a slug disposed in the orifice track, the slug having a bore with a second cross-sectional area less than the first cross-sectional area.

10. The mount of claim 9 further comprising at least one stop disposed in the orifice track.

11. The mount of claim 10 wherein the at least one stop limits travel of the slug in the orifice track.

12. The mount of claim 9 wherein the bore has a constant cross-sectional area.

13. The mount of claim 9 wherein the powertrain component is an engine.

14. The mount of claim 9 wherein the powertrain component is a transmission.
